(19) United States
(12) Patent Application Publication
(10) Pub. No.: US 2026/0187549 A1
(43) Pub. Date: Jul. 2, 2026

(54) ENERGY MANAGEMENT DEVICE AND METHOD OF PROCESSING MULTIPLE VPP EVENTS, BY ENERGY MANAGEMENT DEVICE

(71) Applicant: HANWHA SOLUTIONS CORPORATION, Seoul (KR)

(72) Inventor: Young Woong LEE, Seoul (KR)

(73) Assignee: HANWHA SOLUTIONS CORPORATION, Seoul (KR)

(21) Appl. No.: 19/410,106

(22) Filed: Dec. 5, 2025

(30) Foreign Application Priority Data
Dec. 26, 2024 (KR) 10-2024-0197366

(51) Int. Cl. G06Q 10/0631; G06Q 50/06

(52) U.S. Cl. CPC G06Q 10/0631; G06Q 50/06

(57) ABSTRACT

An energy management device and a method of processing multiple virtual power plant (VPP) events, by the energy management device, are provided. The method includes determining whether to store a new event obtained from a VPP server, in a processing queue, determining whether a first execution period, which is an execution period of the newly stored first event according to the determining, overlaps with a second execution period, which is an execution period of a second event stored before the first event, and establishing an execution plan for the first event and the second event in response to the determining that the first execution period overlaps with the second execution period.

### CROSS-REFERENCE TO RELATED APPLICATION

This application is based on and claims priority under 35 U.S.C. § 119 to Korean Patent Application No. 10-2024-0197366, filed on Dec. 26, 2024, in the Korean Intellectual Property Office, the disclosure of which is incorporated by reference herein in its entirety.

### BACKGROUND

### 1. Field

One or more embodiments relate to an energy management device and a method of processing multiple VPP events by the energy management device.

### 2. Description of the Related Art

As the importance of distributed energy resources has increased recently, virtual power plants (VPPs) are providing flexibility and stability to the power grid by integrating various energy resources such as solar, wind, and battery storage devices with demand management technologies. VPPs manage resources in an integrated manner, adjusting power supply and demand in real time and supporting efficient energy use.

However, existing energy management systems (EMS) are designed around single-event processing, which may lead to performance degradation and resource waste when multiple VPP events occur simultaneously or consecutively within short time intervals. In particular, there is a risk that important events may be delayed or missed due to ineffective handling of interactions between events. Accordingly, the need for technology that may analyze the urgency and importance of multiple events and process these efficiently is emerging.

The background technology described above is technical information that the inventor possessed for the purpose of deriving the present disclosure or obtained in the process of deriving the present disclosure, and cannot necessarily be considered as publicly known technology disclosed to the general public prior to the filing of the present disclosure.

### SUMMARY

One or more embodiments include an energy management device and a method of processing multiple virtual power plant (VPP) events, by the energy management device.

The objectives to be solved by the present disclosure are not limited to those mentioned above, and other objectives and advantages of the present disclosure that are not mentioned may be understood through the following description and will be more clearly understood through embodiments of the present disclosure. In addition, it will be appreciated that the objectives and advantages to be achieved by the present disclosure may be realized by the means and combinations thereof indicated in the patent claims.

According to one or more embodiments, a method of processing multiple VPP events, by an energy management device, includes determining whether to store a new event obtained from a VPP server, in a processing queue, determining whether a first execution period, which is an execution period of the newly stored first event according to the determining, overlaps with a second execution period, which is an execution period of a second event stored before the first event, and establishing an execution plan for the first event and the second event in response to the determining that the first execution period overlaps with the second execution period.

According to one or more embodiments, an energy management device for processing multiple VPP events, includes a communication module that receives an event from a VPP server, a memory storing at least one program, and a processor configured to perform an operation by executing the at least one program, wherein the processor is configured to determine whether to store the event obtained from the VPP server, in a processing queue, determine whether a first execution period, which is an execution period of the first event stored according to the determining, overlaps with a second execution period, which is an execution period of the second event stored before the first event, and establish an execution plan for the first event and the second event, in response to the determining that the first execution period overlaps with the second execution period.

### BRIEF DESCRIPTION OF THE DRAWINGS

These and/or other aspects will become apparent and more readily appreciated from the following description of the embodiments, taken in conjunction with the accompanying drawings in which:

FIG. 1 is a drawing for schematically describing a power supply system;

FIG. 2 is a structural diagram of an energy management device according to an embodiment;

FIG. 3 is a flowchart illustrating a method of, performed by an energy management device according to an embodiment, processing multiple virtual power plant (VPP) events;

FIG. 4 is a diagram illustrating a method of, performed by an energy management device according to an embodiment, determining whether to store a new event obtained from a VPP server in a processing queue;

FIG. 5 is a diagram illustrating a method of, performed by an energy management device according to an embodiment, of determining whether multiple events overlap and determining whether the multiple events are to be executed;

FIG. 6 is a diagram illustrating an event payload according to an embodiment;

FIG. 7 is a diagram illustrating an example in which an energy management device according to an embodiment sets a higher priority to an event with a later acquisition time; and

FIG. 8 is a diagram illustrating an example in which an energy management device according to an embodiment sets a higher priority to an event with a later start time.

### DETAILED DESCRIPTION

The advantages and features of the present disclosure and methods for achieving the advantages and features will be described more fully with reference to the embodiments described in detail together with the accompanying drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terms used in the present specification are merely used to describe particular embodiments, and are not intended to limit the present disclosure. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The present disclosure will be described in detail with reference to the attached drawings below.

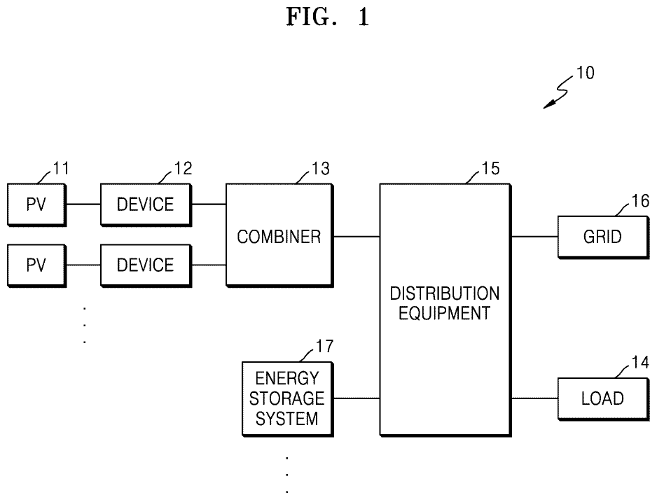

FIG. 1 is a drawing for schematically describing a power supply system.

Referring to FIG. 1, a power supply system 10 may include a solar module 11, a device 12, a load 14, and/or distribution equipment 15. The power supply system 10 may be connected to a power grid 16 that is outside.

At least one solar module 11 may be installed on the roof or exterior wall of a building to generate power. A plurality of solar modules 11 may be connected to form a solar module array.

The solar modules 11 may be connected to the device 12. For example, at least one device 12 may be connected to each solar module 11. As an example, if one device 12 is connected to each solar module 11, the number of devices 12 constituting the power supply system 10 may be the same as the number of solar modules 11.

The device 12 may be a power conditioning system or power conversion system (PCS), which performs power conversion for power generated from the solar module 11. For example, the device 12 may perform a certain conversion on power generated from the solar module 11 and supply the same to other components of the power supply system 10 (e.g., the power grid 16 and/or the load 14, etc.).

Additionally, the device 12 may be module level power electronics (MLPE). For example, the device 12 may be an optimizer or a micro inverter (MI).

As an example, if the device 12 is an optimizer, the device 12 may regulate the power produced from the solar module 11 and output the same to an inverter (e.g., a string inverter). Current converted by the inverter (e.g., direct current converted to alternating current) may be output to the power grid 16 or the load 14.

As another example, if the device 12 is a microinverter, the device 12 may convert power generated from the solar module 11 (e.g., convert direct current into alternating current). The current converted by the device 12 may be output to the power grid 16 or the load 14.

If necessary, the power supply system 10 may further include a combiner 13. At least some of the devices 12 may be connected to the distribution equipment 15 via the combiner 13. For example, power output from a plurality of devices 12 may be combined into one output, by the combiner 13, and supplied to the distribution equipment 15.

The device 12 and the distribution equipment 15 may be connected to each other by a power path that does not include the combiner 13, and at least one device 12 may be connected to the distribution equipment 15 by a power path that does not include the combiner 13, and at least one other device 12 may be connected to the distribution equipment 15 via the combiner 13.

The combiner 13 may control a voltage, current and/or power output from the device 12 according to a power supply status of the solar module 11, the device 12 and/or the power grid 16, and an operation mode of the combiner 13 may be set to a diagnosis mode or an operation mode, etc.

Additionally, the combiner 13 may include an energy management system (EMS) that controls the operation of the combiner 13. The EMS may control the voltage, current and/or power supplied to or output from the combiner 13 according to the power supply status of the solar module 11, the device 12 and/or the power grid 16, and may set the operation mode of the combiner 13 to a diagnosis mode or an operation mode, etc.

The load 14 refers to an object that is installed in an electricity consumer such as a house, commercial facility, or factory and operates by receiving at least one of energy generated by the solar module 11, energy stored in an energy storage system 17, and/or energy supplied from the power grid 16. For example, if the electricity consumer receiving power is a house, the load 14 may include home appliances such as a washing machine, a refrigerator, or TV.

The power grid 16 may include infrastructure systems for generating, transmitting, and distributing power. For example, the power grid 16 may include infrastructure systems such as power plants, substations, and power lines. The power grid 16 may transmit electric energy generated on a power plant to the power supply system 10 or transmit surplus power generated in the power supply system 10 to the outside of the power supply system 10.

For example, commercial power transmitted from the power grid 16 through a power pole may be supplied to a power consumer through a transformer. The power supply system 10 may be implemented as an off-grid system that is not connected to the power grid 16.

The power supply system 10 may further include at least one energy storage system 17. If necessary, the power supply system 10 may include a plurality of energy storage devices 17. The energy storage system 17 may receive and store power generated by the solar module 11 and/or power transmitted from the power grid 16. The energy storage system 17 may store the power and efficiently supply the power by supplying the power to the load 14 when the load 14 needs the same.

The energy storage system 17 may include a battery that stores power and a power conversion module. The battery may include a battery management system (BMS) that monitors the state of charge (SOC), state of health (SOH), voltage and/or current of a battery, performs diagnostics on the battery, and performs safety functions such as current cutoff.

Additionally, the power conversion module may be a PCS that performs conversion between battery-side power and opposite-side power. For example, the PCS may convert between direct current on the battery side and alternating current on the opposite side. As an example, the PCS may include a bidirectional DC-DC converter that is connected to a battery and converts voltage, and a bidirectional inverter that connects the DC-DC converter and the outer side of the energy storage system 17.

Additionally, the energy storage system 17 may further include an EMS that controls the operation of the energy storage system 17. The EMS may control the voltage, current and/or power supplied to or output from the energy storage system 17 according to the power supply status of the battery and/or the power grid 16, and may set the operating mode of the energy storage system 17 to a diagnostic mode or an operating mode, etc.

As needed, an EMS coupled to a certain component of the power supply system 10 may control not only the operation of the certain component, but may also further control the operation of other components of the power supply system 10. For example, an EMS coupled to the combiner 13 or an EMS coupled to the energy storage system 17 may control both the operation of the combiner 13 and the operation of the energy storage system 17.

The distribution equipment 15 may provide electrical connection between components of the power supply system 10 and control the power flow of the power supply system 10. For example, the distribution equipment 15 may electrically connect the solar module 11 and the load 14 to each other. As an example, the distribution equipment 15 may be connected to the device 12 connected to the solar module 11 to thereby electrically connect the solar module 11 and the load 14. If necessary, the distribution equipment 15 may be further connected to at least one of the energy storage system 17 and the power grid 16.

For example, the distribution equipment 15 may be a distribution panel that distributes power within the power supply system 10. As an example, the distribution equipment 15 may be a master service panel (MSP) that distributes power generated from the solar module 11 to the load 14, etc.

As another example, the distribution equipment 15 may be a main controller that performs power distribution within a power supply system and controls each device 12. As an example, the main controller may include a switch, a circuit breaker, and a control unit. The switch, the circuit breaker, and the control unit may each be implemented as independent devices, or at least some of the switch, the circuit breaker, and the control unit may be included in one device.

The main controller may include a switch that controls the electrical connection between components connected to the main controller, such as the device 12 and the load 14. For example, the main controller may include a relay or power semiconductor, which provides or blocks electrical connection to the device 12 and/or the energy storage system 17 depending on the operating status of each component of the power supply system 10.

The main controller may perform an emergency shutdown (rapid shutdown) to stop the power generation of the solar module 11 in an emergency situation such as an overcurrent occurring in the power supply system 10. To this end, the main controller may include a circuit breaker that blocks the connection between the device 12 and the load 14.

The main controller may include a control unit that controls the overall operation of the main controller. In addition to the main controller, the control unit may control the operation of other components of the power supply system 10 (e.g., the device 12 or the energy storage system 17).

The control unit may control voltage, current and/or power output from or supplied to each component according to the power supply status of the solar module 11, the device 12, the combiner 13, the load 14, the power grid 16 and/or the energy storage system 17. Additionally, the control unit may set the operating mode of the main controller, the device 12 and/or the energy storage system 17 to a diagnostic mode or an operating mode, etc.

For example, the control unit may control the solar module 11, the device 12, the combiner 13, and/or the energy storage system 17 based on the status of the power supply system 10. As an example, the control unit may control other components of the power supply system 10 (e.g., the device 12) by causing the main controller to communicate with the other components of the power supply system 10. Communication between the main controller and the other components of the power supply system 10 may be performed using power line communication (PLC), but is not limited thereto.

As an example, the control unit may control the device 12 according to a power generation status of the solar module 11. For example, the main controller may receive a control command from a server that monitors the power generation status of the solar module 11, and the control unit may control the device 12 according to the control command.

The main controller may supply power to at least a portion of the load 14 when the power supply from the power grid 16 is not smooth (e.g., in an off-grid situation). For example, when the power supply from the power grid 16 is not smooth, the main controller may preferentially supply the power generated from the solar module 11 and/or the power stored in the energy storage system 17 to a backup load that has a relatively high need for stable power supply.

The power supply system 10 may further include an auxiliary power generation device (e.g., a diesel generator, etc.) that generates power in a different manner other than solar power generation. For example, an auxiliary power generation device may be further connected to the distribution equipment 15. In cases where the backup load cannot be responded with only the solar module 11 and the energy storage system 17 due to environmental factors such as time zone or weather, the main controller may supply power generated by the auxiliary power generation device to the backup load.

The control unit may be implemented by at least one processor. The processor may process a computer program command by performing basic arithmetic, logic, and input/output operations. Here, commands may be provided from an internal memory of the main controller or from an external device. Additionally, the processor may control the overall operation of other components included in the main controller.

The processor may perform at least some of data analysis, processing, and result information generation for performing the above-described operations by using at least one of machine learning, neural network, or deep learning algorithm as a rule-based or artificial intelligence algorithm. Examples of the neural network may include neural network models based on architectures such as convolutional neural network (CNN), deep neural network (DNN), and recurrent neural network (RNN).

For example, the processor may be implemented as an array of a number of logic gates, or may be implemented as a combination of a general-purpose microprocessor and a memory storing a program that may be executed on the microprocessor. For example, the processor may include a general-purpose processor, a central processing unit (CPU), a microprocessor, a digital signal processor (DSP), a controller, a microcontroller, a state machine, etc.

In some environments, the processor may include an application-specific integrated circuit (ASIC), a programmable logic device (PLD), a field-programmable gate array (FPGA), etc. For example, the processor may refer to a combination of processing devices, such as a combination of a DSP and a microprocessor, a combination of a plurality of microprocessors, a combination of one or more microprocessors in conjunction with a DSP core, or a combination of any other such components.

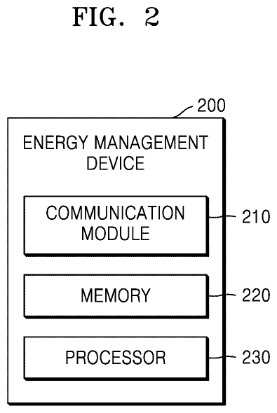

FIG. 2 is a structural diagram of an energy management device according to an embodiment.

According to an embodiment, an energy management device 200 may be included in the energy storage system 17 of FIG. 1. The energy management device 200 may comprehensively control and manage the power flow between the solar module 11, the device 12, the distribution equipment 15, and the power grid 16 that are linked with the energy storage system 17.

Specifically, the energy management device 200 distributes power generated from the solar module 11, power stored in the energy storage system 17, and power supplied from the power grid 16, in an optimized manner based on a demand response (DR) signal received from a virtual power plant (VPP) server. Additionally, the energy management device 200 may set a priority of power supplied to the load 14 through the distribution equipment 15 or perform an operation of transmitting surplus power to the power grid 16.

Referring to FIG. 2, the energy management device 200 may be included in the energy storage system 17 of FIG. 1, and have a function of controlling and managing the operation of the energy storage system 17. The energy management device 200 may include a communication module 210, a memory 220, and a processor 230.

The communication module 210 receives or transmits an event through communication with an external VPP server. Specifically, the communication module 210 may obtain event data including a DR signal from the VPP server. The communication module 210 may store data including a payload of an event received from the VPP server, in the memory 220, and the stored data may be used by the processor 230 to analyze the event in a processing queue and establish an execution plan.

The VPP server refers to a system that comprehensively manages and optimizes a plurality of distributed energy resources for efficient operation of power resources. The VPP server may monitor and control various resources, including distributed resources such as solar modules, energy storage devices, and diesel generators, as well as power consumption devices and loads. In an embodiment, the VPP server may generate a DR event based on data collected from distributed resources and transmit the event to the energy management device 200. A DR event may include information directing to increase or reduce power consumption for a specific period of time.

The memory 220 may be a device that stores data required for the operation of the energy management device 200 and include an operating schedule, DR events, and status information (e.g., SOC, SOH) of the energy storage system 17. In particular, the memory 220 may store event data received from the VPP server, in a processing queue, and support the processor 230 to make appropriate decisions based on the data.

The processor 230 may analyze event data received from the VPP server, to determine whether to store the same in the processing queue, determine whether there is an overlap between execution periods of a new event and an existing event, and establish an event execution plan. For example, the processor 230 may set priorities for received events and establish an execution plan to execute only a highest-priority event and terminate other events.

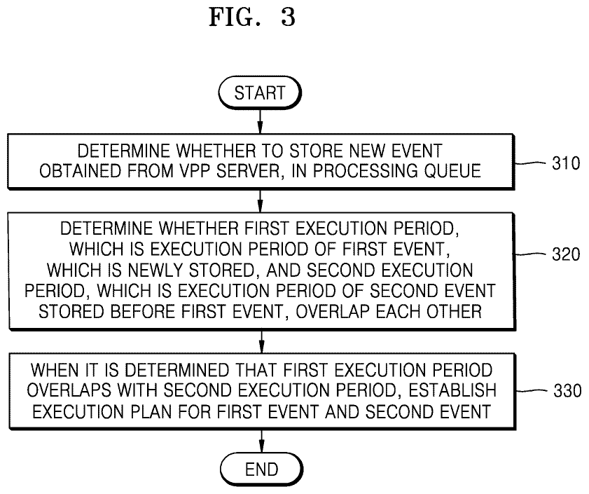

FIG. 3 is a flowchart illustrating a method of, performed by an energy management device according to an embodiment, processing multiple VPP events.

Referring to FIG. 3, the method of, performed by an energy management device, processing multiple VPP events may include operations processed by an EMS included in the energy storage system 17 of FIG. 1, the energy management device 200 or the processor 230 of FIG. 2.

In operation 310, the energy management device 200 may determine whether to store a new event obtained from the VPP server, in the processing queue.

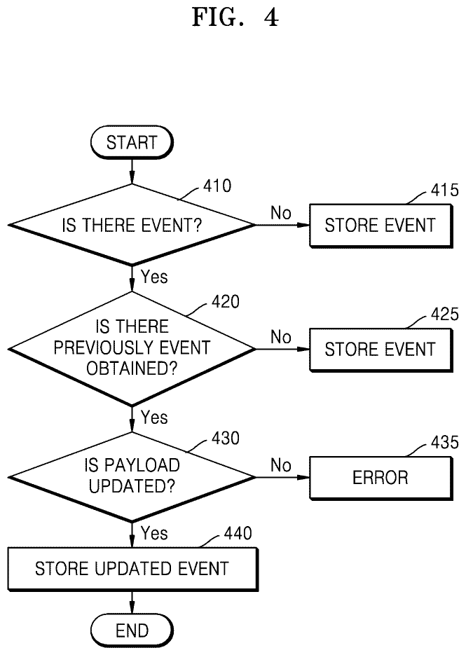

That is, the energy management device 200 may determine whether the obtained event data is duplicated or valid and whether the event data is an event that needs to be stored in the processing queue. An example of determining whether to store a new event in the processing queue is described below with reference to FIG. 4.

FIG. 4 is a diagram illustrating a method of, performed by an energy management device according to an embodiment, determining whether to store a new event obtained from a VPP server, in a processing queue.

Referring to FIG. 4, in operation 410, the energy management device may check whether there is an event in a priority processing queue when a new event is obtained from a VPP server.

In operation 415, the energy management device may immediately store the newly obtained event in the processing queue when there is no event in the processing queue.

In operation 420, when there is an event in the processing queue, the energy management device may determine whether there is already a new event in the processing queue.

In an embodiment, the energy management device may compare payloads of a new event and an event existing in the processing queue to determine whether there is previously an event identical to the new event in the processing queue. For example, the energy management device may check a unique value (event id) of an event included in an event payload.

In operation 425, the energy management device may store the new event in response to the new event previously not being present in the processing queue.

In operation 430, when there is a new event in the processing queue, the energy management device may determine whether a payload of the new event has been updated.

In operation 435, the energy management device may determine the payload being not updated, as an error. This indicates that in a normal scenario, a situation where the same event is obtained repeatedly without an update should not occur.

In operation 440, the energy management device may store the updated new event in response to the payload being updated.

As described, the energy management device 200 may efficiently determine whether to store events received from the VPP server in the processing queue, by checking whether there are duplicates of the events received from the VPP server and whether the payload has been updated.

Referring back to FIG. 3, in operation 320, according to the determining whether an event is to be stored or not in operation 310, the energy management device 200 may determine whether a first execution period, which is an execution period of a first event, which is newly stored, overlaps with a second execution period, which is an execution period of the second event stored before the first event.

According to an embodiment, first, the energy management device 200 may determine whether the second event which is stored earlier than the newly stored first event is progressing.

In response to the second event not progressing, it may be determined whether a first start time, which is a start time of the first event, has passed. Next, in response to the first start time having passed, the energy management device may remove the first event from the processing queue, and maintain the first event in the processing queue in response to the first start time not having passed.

In response to the second event progressing, the energy management device may determine whether the first event overlaps with the second event by determining whether at least one of a start time and an end time of the first event is included in the second execution period.

In operation 330, when it is determined that the first execution period overlaps with the second execution period, the energy management device 200 may establish an execution plan for the first event and the second event.

According to an embodiment, the energy management device may set priorities between the first event and the second event. For example, a highest priority may be set for an event with a latest start time.

According to an embodiment, the energy management device may determine whether the first event overlaps with the second event at a current point in time.

In response to determining that the first event overlaps with the second event at the current point in time, only a highest-priority event may be executed and the other events may be terminated.

In response to determining that the first and second events do not overlap at the current point in time, a plan may be established such that, when a start time of the highest-priority event arrives, the highest-priority event is executed and the other events are terminated.

According to an embodiment, the energy management device may determine whether an end time of the other events is after an end time of the highest-priority event, and, based on a determination result, determine whether to resume the other events.

For example, the energy management device may establish a plan to resume, in response to the other events'end time being after the highest-priority event's end time, the other events when the highest-priority event ends, and to terminate the other events in response to the other events'end time not being after the highest-priority event's end time.

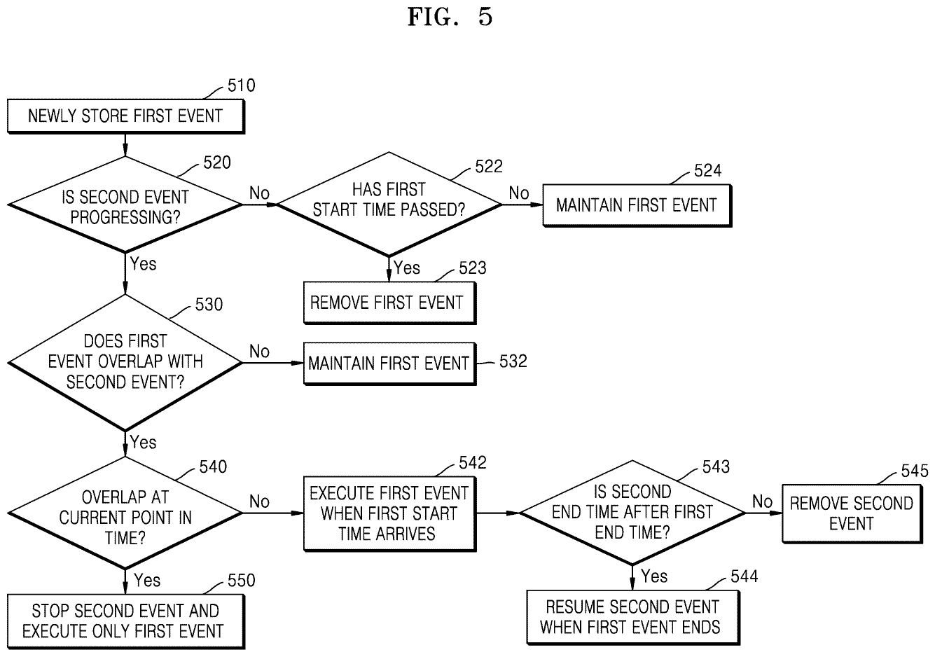

FIG. 5 is a diagram illustrating a method of, performed by an energy management device according to an embodiment, determining whether multiple events overlap and determining whether the multiple events are to be executed.

Referring to FIG. 5, in operation 510, the energy management device 200 stores a new event (first event) in a processing queue.

In operation 520, the energy management device 200 determines whether a second event is progressing.

When the second event is not progressing, in operation 522, whether the start time of the first event has passed is determined. When the start time has passed (operation 523), the first event is removed from the processing queue. When the start time has not passed (operation 524), the first event is maintained in the processing queue.

When the second event is progressing, in operation 530, the energy management device 200 determines whether execution periods of the first event and the second event overlap each other. When there is no overlap, the first event is maintained (operation 532).

When the execution periods of the first event and the second event overlap, it is determined again in operation 540 whether the first and second events overlap at a current point in time.

When a result of determining of operation 540 shows that the first event overlaps with the second event at the current point in time, the energy management device 200 stops the second event and executes only the first event in operation 550.

When a result of determining of operation 540 shows that the first event and the second event do not overlap at the current point in time, then in operation 542, the energy management device 200 establishes an execution plan to execute the first event when the start time of the first event arrives.

Then, the energy management device 200 determines in operation 543 whether an end time of the second event is after the end time of the first event.

When the end time of the second event is after the end time of the first event, in operation 544, the energy management device 200 establishes an execution plan to resume the second event after the first event ends.

When the end time of the second event is not after the end time of the first event, in operation 545, the energy management device 200 establishes an execution plan to remove the second event without resuming the same.

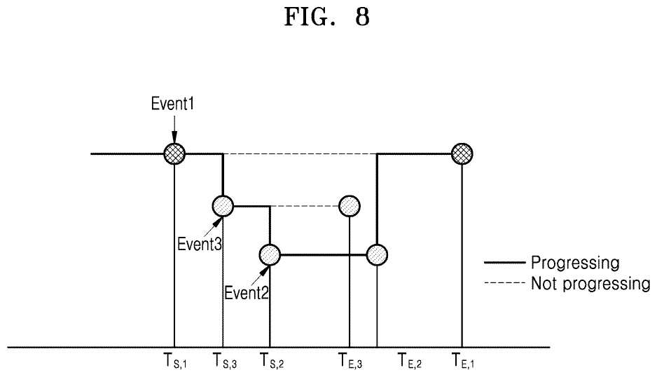

FIG. 5 illustrates an example in which the energy management device 200 of the present disclosure processes a new event as a priority. That is, the new event indicates an event with a later acquisition time in an event payload. However, criteria for setting the priority of an event by the energy management device 200 of the present disclosure are not limited thereto. In another embodiment, priorities may be set based on the start time of an event. In this case, an event with a later start time may be given priority. Another embodiment is described with reference to FIG. 8 below.

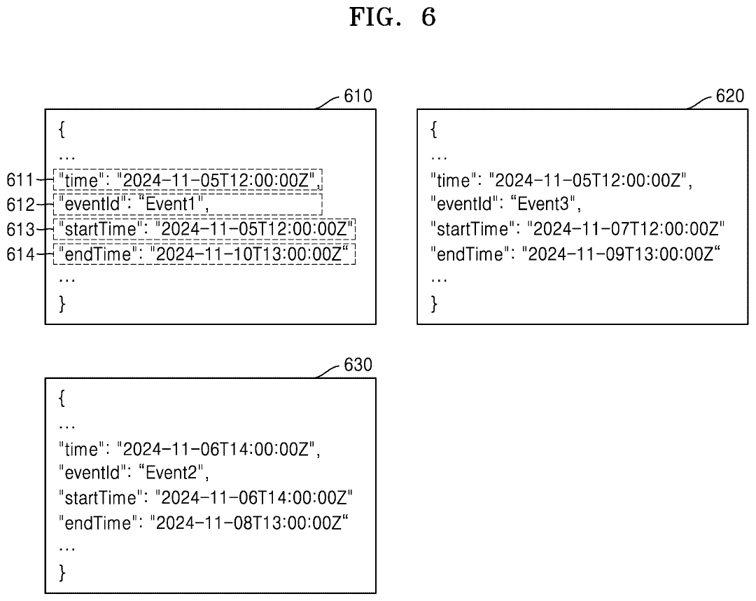

FIG. 6 is a diagram illustrating an event payload according to an embodiment.

Referring to FIG. 6, event payloads 610, 620, and 630 include items such as an acquisition time (time, 611) of each event, an event unique value (eventid, 612), an event start time (startTime, 613), and an event end time (endTime, 614).

The acquisition time 611 indicates a time at which an event was received from a VPP server and may be used as a criterion for determining priority among multiple events.

The event unique value 612 is a unique value for identifying each event and may be used to determine whether there is an overlap between an event already existing in a processing queue and a new event.

The event start time 613 indicates a point in time at which the execution of an event begins, and may be used as a reference when establishing an execution plan for the event in the processing queue. The event end time 614 indicates a point in time at which execution of an event ends, and may provide information necessary for establishing an execution plan, such as whether to resume the event or not.

In the present disclosure, an execution period indicates a period of time from the start time to the end time of each event, and may be used to determine whether there is an overlap between each event in the processing queue. For example, the energy management device may establish an execution plan to execute a higher-priority event and stop other events when the execution period of a new event overlaps with the execution period of an existing event.

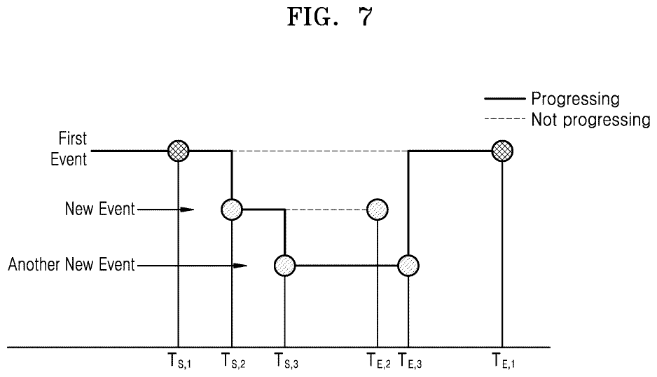

FIG. 7 is a diagram illustrating an example in which an energy management device according to an embodiment sets a higher priority to an event with a later acquisition time.

Referring to FIG. 7, while a first event is progressing initially, a new event and another new event are sequentially obtained from a VPP server. The energy management device 200 sets priorities according to acquisition times of the events, and when execution periods overlap, events obtained later are executed with higher priority, and events that were previously progressing are stopped at the start time of a new event.

For example, when a start time T_{S,1} of the first event arrives, execution of the first event begins, but when a new event, the execution period of which overlaps with an execution period T_{S,1} to T_{E,1} of the first event, is obtained, the first event is stopped at a start time T_{S,2} of the new event, and the new event is executed. When another new event is obtained, which has an execution period that overlaps with an execution period T_{S,2} to T_{E,2} of the new event, the new event is stopped at a start time T_{S,3} of another new event, and another new event is executed.

Additionally, when an end time of a stopped event is earlier than an end time of an event obtained later than the stopped event, the stopped event is not resumed even if the later obtained event ends, and when the end time of the stopped event is later than the end time of the later obtained event, the stopped event is resumed when the later obtained event ends.

For example, as the end time T_{E,2} of the new event is earlier than an end time T_{E,3} of another new event, which is a highest-priority event, the new event is not resumed after being stopped, but as the end time T_{E,1} of the first event is later than the end time T_{E,3} of another new event, the first event is resumed at the end time T_{E,3} of another new event.

FIG. 8 is a diagram illustrating an example in which an energy management device according to an embodiment sets a higher priority to an event with a later start time.

A start time of each of a first event (Event1), a second event (Event2), and a third event (Event3) arrives. Here, the first event, the second event, and the third event may be obtained simultaneously or sequentially. Referring to FIG. 8, priorities of the second event, the third event, and the first event may be set in order of a latest start time.

Thus, when the start time T_{S,1} of the first event arrives, the first event is executed (progressing), but when the start time T_{S,3} of the third event overlapping the first event arrives, the first event, which has a lower priority, is not executed (not progressing) and is stopped.

Additionally, when the start time T_{S,2} of the second event arrives, the third event, which has a lower priority than the second event, is stopped from executing. And, as the end time T_{E,3} of the third event is before the end time T_{E,2} of the second event, the third event is not resumed. However, as the end time T_{E,1} of the first event is after the end time T_{E,2} of the second event, when the second event ends, the first event is resumed.

Meanwhile, embodiments according to the present disclosure may be implemented in the form of a computer program that may be executed through various components on a computer, and such a computer program may be recorded on a computer-readable medium. The medium may include magnetic media such as hard disks, floppy disks and magnetic tapes, optical recording media such as CD-ROMs and DVDs, magneto-optical media such as floptical disks, and hardware devices specifically configured to store and execute program instructions such as ROM, RAM, flash memory, etc.

The computer program may be specially designed and configured for the present disclosure or may be well-known to and available to one of ordinary skill in the art of computer software. Examples of the computer program may include not only machine language code generated by using a compiler but also high-level language codes that can be executed by a computer by using an interpreter or the like.

According to an embodiment, the method according to various embodiments of the present disclosure may be included in a computer program product to be provided. The computer program product may be traded as a product between a seller and a buyer. The computer program product may be distributed in the form of a machine-readable storage medium (e.g., compact disc read only memory (CD-ROM)), or may be distributed online (e.g., by download or upload) via an application store (e.g., Play Store™) or directly between two user devices. In the case of online distribution, at least a portion of the computer program product may be temporarily stored or temporarily generated in a device-readable storage medium, such as the memory of a manufacturer's server, an application store's server, or an intermediary server.

According to the present disclosure described above, a technology for efficiently processing multiple VPP events, by an energy management device, may be provided. When multiple events occur simultaneously or at short time intervals, the processing order may be determined based on the execution period and priority of each event, thereby optimizing resource usage and maximizing the processing efficiency of the energy management device.

By determining whether the execution periods of events overlap, high-priority events may be preprocessed, and an execution plan to stop or eliminate execution of low-priority events may be established, thereby preventing conflicts and duplicate processing between the events.

Additionally, a system's response speed may be improved by analyzing interactions between events to prevent unnecessary duplicate processing and by preprocessing events that require quick decision-making. The effects of the embodiments are not limited to the effects mentioned above, and other effects not mentioned will be clearly understood by those skilled in the art from the description of the present disclosure.

What is claimed is:

1. A method of processing multiple virtual power plant (VPP) events, the method comprising:
determining whether to store a new event obtained from a VPP server, in a processing queue;
determining whether a first execution period, which is an execution period of the newly stored first event according to the determining, overlaps with a second execution period, which is an execution period of a second event stored before the first event; and
establishing an execution plan for the first event and the second event in response to the determining that the first execution period overlaps with the second execution period.

2. The method of claim 1, wherein the determining of whether to store the new event obtained from a VPP server, in the processing queue, comprises:
checking whether the new event is already in the processing queue; and
storing, in response to the new event not existing in the processing queue, the new event, and
determining, in response to the new event already existing in the processing queue, whether a payload of the new event has been updated.

3. The method of claim 2, wherein the determining of whether to store the new event obtained from a VPP server, in the processing queue, further comprises storing the new event that is updated, in response to the payload being updated.

4. The method of claim 1, wherein the determining of whether the first execution period overlaps with the second execution period comprises:
determining whether the second event is progressing;
determining, in response to the second event not progressing, whether a first start time, which is a start time of the first event, has passed; and
removing, in response to the first start time having passed, removing the first event from the processing queue, and maintaining, in response to the first start time not having passed, the first event in the processing queue.

5. The method of claim 1, wherein the determining of whether the first execution period overlaps with the second execution period comprises
determining, in response to the second event progressing, whether at least one of a start time and an end time of the first event is included in the second execution period.

6. The method of claim 1, wherein the establishing of the execution plan comprises setting priorities between the first event and the second event,
wherein a highest priority is set for an event with a latest start time.

7. The method of claim 6, wherein the establishing of the execution plan comprises determining whether the first event overlaps with the second event at a current point in time.

8. The method of claim 7, wherein the establishing of the execution plan comprises, in response to determining that the first event overlaps with the second event at the current point in time, executing only a highest-priority event with the highest priority and terminating the other events.

9. The method of claim 7, wherein the establishing of the execution plan comprises establishing a plan that, in response to determining that the first event does not overlap with the second event at the current point in time, when a start time of a highest-priority event with the highest priority arrives, executes the highest-priority event is and terminates the other events.

10. The method of claim 9, wherein the establishing of the execution plan comprises:
determining whether an end time of the other events is after an end time of the highest-priority event; and
determining whether to resume the other events based on a result of the determining.

11. The method of claim 10, wherein the determining of whether to resume the other events comprises establishing a plan
that, in response to the end time of the other events being after the end time of the highest-priority event, resumes the other events when the highest-priority event ends, and
that, in response to the end time of the other events not being a point in time after the end time of the highest-priority event, removes the other events.

12. An energy management device for processing multiple virtual power plant (VPP) events, the device comprising:
a communication module that receives an event from a VPP server;
a memory storing at least one program; and
a processor configured to perform an operation by executing the at least one program,
wherein the processor is further configured to
determine whether to store the event obtained from the VPP server, in a processing queue,
determine whether a first execution period, which is an execution period of the first event stored according to the determining, overlaps with a second execution period, which is an execution period of the second event stored before the first event, and
establish an execution plan for the first event and the second event, in response to the determining that the first execution period overlaps with the second execution period.

13. The energy management device of claim 12, wherein the processor is further configured to determine, in response to the second event progressing, whether the first event overlaps with the second event by determining whether at least one of a start time and an end time of the first event is included in the second execution period.

14. The energy management device of claim 12, wherein the processor is further configured to set priorities between the first event and the second event, and
a highest priority is set for an event with a latest start time.

15. The energy management device of claim 14, wherein the processor is further configured to determine whether the first event overlaps with the second event at a current point in time.

16. The energy management device of claim 15, wherein the processor is further configured to, in response to determining that the first event overlaps with the second event at the current point in time, execute only a highest-priority event with the highest priority and terminate the other events.

17. The energy management device of claim 15, wherein the processor is further configured to establish, in response to determining that the first event does not overlap with the second event at the current point in time, a plan that, when a start time of a highest-priority event with the highest priority arrives, executes the highest-priority event and terminates the other events.

18. The energy management device of claim 17, wherein the processor is further configured to determine whether an end time of the other events is after an end time of the highest-priority event, and determine whether to resume the other events, based on a result of the determining.

19. The energy management device of claim 18, wherein the processor is further configured to establish a plan
that, in response to the end time of the other events being after the end time of the highest-priority event, resumes the other events when the highest-priority event ends, and
that, in response to the end time of the other events not being a point in time after the end time of the highest-priority event, removes the other events.

20. The energy management device of claim 12, wherein the energy management device manages power generated from solar module.
